(19) United States
(12) Patent Application Publication
(10) Pub. No.: US 2024/0403569 A1
(43) Pub. Date: Dec. 5, 2024

(54) USING LARGE LANGUAGE MODELS TO GENERATE ELECTRONIC MESSAGES ASSOCIATED WITH CONTENT ITEMS

(71) Applicant: Highspot, Inc., Seattle, WA (US)

(72) Inventors: Kurt William Berglund, Kirkland, WA (US); Lowell Geoffrey Vaughn, Bellevue, WA (US); Tobias Kahn, Bellevue, WA (US); Won Park, Kirkland, WA (US); Bryan Pirtle, Reno, NV (US)

(21) Appl. No.: 18/679,231

(22) Filed: May 30, 2024

Related U.S. Application Data
(60) Provisional application No. 63/505,405, filed on May 31, 2023.

(51) Int. Cl. G06F 40/40; G06F 40/174

(52) U.S. Cl. CPC G06F 40/40; G06F 40/174

(57) ABSTRACT

A system automatically generates electronic messages based on a plurality of signals received in a content management platform. The system receives, at a user interface generated by a computer system for display by a user device, an input to generate an electronic message. The system processes a plurality of signals retrieved based on the received input and generates a prompt to a large language model (LLM) to cause the LLM to generate content for the electronic message, where the prompt is generated at least in part based on the processing of the plurality of signals. The system populates, into the user interface, content for the electronic message that is generated based on output by the LLM.

### CROSS-REFERENCE TO RELATED APPLICATION

This application claims the benefit of U.S. Provisional Patent Application No. 63/505,405, filed May 31, 2023, which is incorporated herein by reference in its entirety.

### BRIEF DESCRIPTION OF THE DRAWINGS

Detailed descriptions of implementations of the present invention will be described and explained through the use of the accompanying drawings.

FIG. 1 is a block diagram illustrating an environment in which searches against a corpus of documents are conducted, according to some implementations.

FIGS. 2A-2F are example user interfaces that illustrate a process by which messages are generated, according to some implementations.

FIG. 3 is flowchart illustrating a process for generating electronic messages, according to some implementations.

FIG. 4 is a block diagram of a transformer neural network, which may be used in examples of the present disclosure.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Digital communication is ubiquitous in personal and professional interactions. With the rise of artificial intelligence and machine learning technologies, there is an increasing demand for systems that can autogenerate electronic messages. However, while current technologies enable autogeneration of content, autogenerating effective electronic messages—that contain accurate information and are sufficiently tailored to the communication preferences of recipients to effectively communicate the accurate information to the recipient—is more difficult. It is especially challenging to autogenerate effective messages in a computationally efficient manner.

The disclosed system automatically generates electronic messages based on a plurality of signals received in a content management platform. The system leverages data associated with a sender of the message, a recipient of the message, content items to be attached to the message, and/or activity data that indicates activities of senders or recipients with respect to other senders or recipients or with respect to content items. By leveraging a plurality of signals that are available within a content management platform, the computer system can generate messages that effectively communicate with a recipient and are likely to receive a response from or subsequent action by a recipient, without requiring the sender to laboriously search and review content within the platform.

In some implementations, a computer system receives, at a user interface generated by a computer system for display by a user device, an input to generate an electronic message. The system processes a plurality of signals retrieved based on the received input and generates a prompt to a large language model (LLM) to cause the LLM to generate content for the electronic message, where the prompt is generated at least in part based on the processing of the plurality of signals. The system populates, into the user interface, content for the electronic message that is generated based on output by the LLM.

In some implementations, a content management platform uses a large language model (LLM) to generate message content for electronic communications associated with content items. In an example, the content management platform generates a message for a user who is sharing a content item with another person, where the message explains what the content item is and why the user is sharing the content item with the person. Content items can be associated with a description that includes a summary of subject matter of the content item and/or how the content item should be used (such as a purpose of the content item or its target audience). To generate message content associated with the content item, the content management platform sends the description to the LLM with a prompt instructing the LLM to generate a type of message based on the description.

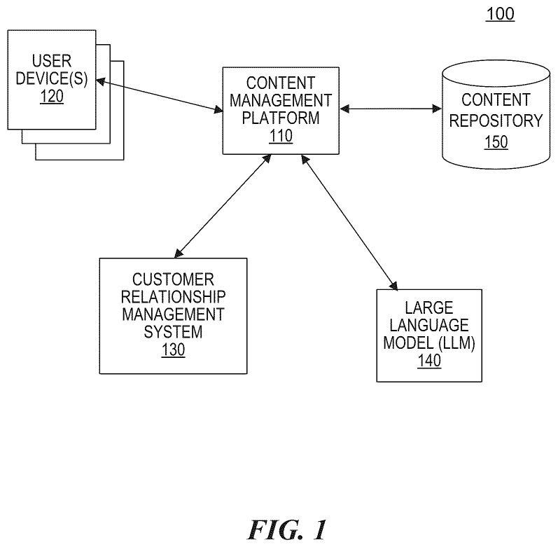

FIG. 1 is a block diagram illustrating an environment 100 in which electronic communications based on content items are generated. As shown in FIG. 1, the environment can include a content management platform 110, user devices 120, a customer relationship management system 130, and a large language model (LLM) 140. The content management platform 110 maintains, or is configured to access, a content repository 150 that stores content and associated content metadata.

The content management platform 110 enables access to content items in the content repository 150. The content management platform 110 can provide user interfaces via a web portal or application, which are accessed by the user devices 120 to enable users to create content items, view content items, share content items, or search content items. In some implementations, the content management platform 110 includes enterprise software that manages access to a company's private data repositories and controls access rights with respect to content items in the repositories. However, the content management platform 110 can include any system or combination of systems that can access a repository of content items, whether that repository stores private files of a user (e.g., maintained on an individual's hard drive or in a private cloud account), private files of a company or organization (e.g., maintained on an enterprise's cloud storage), public files (e.g., a content repository for a social media site, or any content publicly available on the Internet), or a combination of public and private data repositories.

The content repository stores content items such as documents, videos, images, audio recordings, 3D renderings, 3D models, or immersive content files (e.g., metaverse files). Documents stored in the content repository can include, for example, technical reports, sales brochures, books, web pages, transcriptions of video or audio recordings, presentations, or any other type of document. In some implementations, the content management platform 110 enables users to add content items in the content repository to a person collection of items. These collections, referred to herein as “spots,” can include links to content items in the content repository, copies of items in the content repository, and/or external content items (or links to external content items) that are not stored in the content repository. Users can create spots for their own purposes (e.g., to keep track of important documents), for organizing documents around a particular topic (e.g., to maintain a set of documents that are shared whenever a new client is onboarded), for sharing a set of documents with other users, or for other purposes. In some cases, users may be able to access the spot created by other users.

The content management platform 110 can provide interfaces for users to interact with content in the content repository, such as interfaces that enable users to view, create, modify, or share content items. Alternatively, the content management platform 110 maintains a set of APIs that enable other services, such as a native filesystem on a user device, to access the content items in the content repository and facilitate user interaction with the content items.

The content management platform 110 can maintain interaction data quantifying how users interact with the content items in the content repository. Interaction data for a content item can include, for example, a number of users who have viewed the item, user dwell time within the item (represented as dwell time in the content item overall and/or as dwell time on specific pages or within particular sections of the content item), number of times the item has been shared with internal or external users, number of times the item has been bookmarked by a user or added to a user's collection of documents (a “spot”), number of times an item has been edited, type and nature of edits, etc. When the content repository stores files of a company or organization, the interaction data can be differentiated according to how users inside the company or organization interact with the content and how users outside the company or organization interact with it.

The content management platform 110 can include a calendar system that maintains a list of past and upcoming meetings for a user or set of users. Meetings can be recorded as events on a user's calendar and can be shared with other users who are invited to attend the meetings. The content management platform 110 can then process meetings to determine who attended the meetings, what topics were discussed, and/or what content was shared during the meeting. Alternatively, the content management platform 110 can access calendars maintained by a third-party provider, such as Google Calendar or Microsoft Outlook Calendar. A user can link their calendar or events within their calendar to the content management platform 110 to enable meetings on the calendar to be processed by the content management platform 110.

The content management platform 110 can include applications or functionality to send electronic messages, receive electronic messages, and/or process messages sent or received using other, third-party applications. The platform 110 can track when messages have been read or replied to. Furthermore, the platform 110 can process messages that are sent or received in association with the platform. Messages can be processed to detect features, such as tone, style, formality level, formatting features, time of day the message was sent or read, or an amount of time that elapsed between when the message was sent and when a response was received.

The content management platform 110 can further track performance metrics associated with the messages, which can be correlated with message features in order to predict the features that are likely to improve performance metrics. Performance metrics can include, for example, metrics that indicate whether a message was opened, whether the message received a reply (in the form of a return message sent by the recipient of the original message or a subsequent communication by a different communication modality, such as telephone call), whether a follow-up meeting was scheduled, or whether a client purchased something or engaged a service after receiving the message. Performance metrics can be evaluated across all messages sent or received by users in an organization. Alternatively, performance metrics can be selectively evaluated for individual users (e.g., which message features are most likely to make certain recipient respond), for a group of users who have a shared characteristic (e.g., for executives at medium-sized companies, which message features are most likely to lead to a purchase or engagement of a service), for certain types of messages (e.g., which features are most likely to cause an initial introductory email to receive a response), for certain senders or sender characteristics, etc.

In an example use case, the content management platform 110 is a sales enablement platform. The platform can store various content items that are used by a sales team or their customers, such as pitch decks, product materials, demonstration videos, or customer case studies. Members of the sales team can use the platform 110 to organize and discover content related to the products or services being offered by the team, communicate with prospective customers, share content with potential and current customers, and access automated analytics and recommendations to improve sales performance. Meetings analyzed by the platform 110 can include sales meetings, in which a member of a sales team communicates with customers or potential customers to, for example, pitch products or services or to answer questions. However, the platform 110 can be used for similar purposes outside of sales enablement, including for workplace environments other than sales and for formal or informal educational environments.

The content management platform 110 may integrate with or receive data from external applications on the user device or provided by a third-party service. For example, the content management platform 110 may integrate with an electronic communication application, such as an email client, that enables the content management platform 110 to generate and send messages via the application. In another example, instead of integrating with a platform that maintains calendar or communication data, the content management platform 110 receives calendar or communication data that indicates, for example, the number of times a given sender has communicated with a given recipient, frequency of such communications, nature of such communications, or a number of times the sender and recipient have scheduled meetings.

The CRM system 130 is a system for managing relationships and interactions with customers and potential customers. For example, a company will use the CRM system 130 to manage the company's sales or marketing efforts. The CRM system 130 can store objects related to entities with which the company has interacted or plans to interact. These objects can include, for example, an account object that stores information about a customer's account, an opportunity object that stores information about a pending sale or deal, or a lead object that stores information about potential leads for sales or marketing efforts.

The LLM 140 can include commercially available, fine-tuned, or custom language models that are configured to perform language analysis and generation tasks in response to prompts received from the content management platform 110.

The content management platform 110 uses the LLM 140 to generate electronic messages or message content. Messages can be any form of electronic communication, such as emails, social media posts, SMS messages, or messages transmitted within proprietary services such as Slack, Signal, WeChat, or WhatsApp. Some of the messages generated by the platform 110 are generated based on content items in the content repository 150 and can be configured to carry the content item in a link or attachment. Other messages can be associated with a content item but not carrying or transmitting the content item. For example, the techniques described herein can be used to generate additional emails in an email thread in which a content item was attached to only the first email in the thread. Similarly, the disclosed techniques can be used to generate a script for a voice call or a video describing a content item, where the content item is provided to a recipient of the call or video by another type of communication.

### User Interfaces for Automated Electronic Message Generation

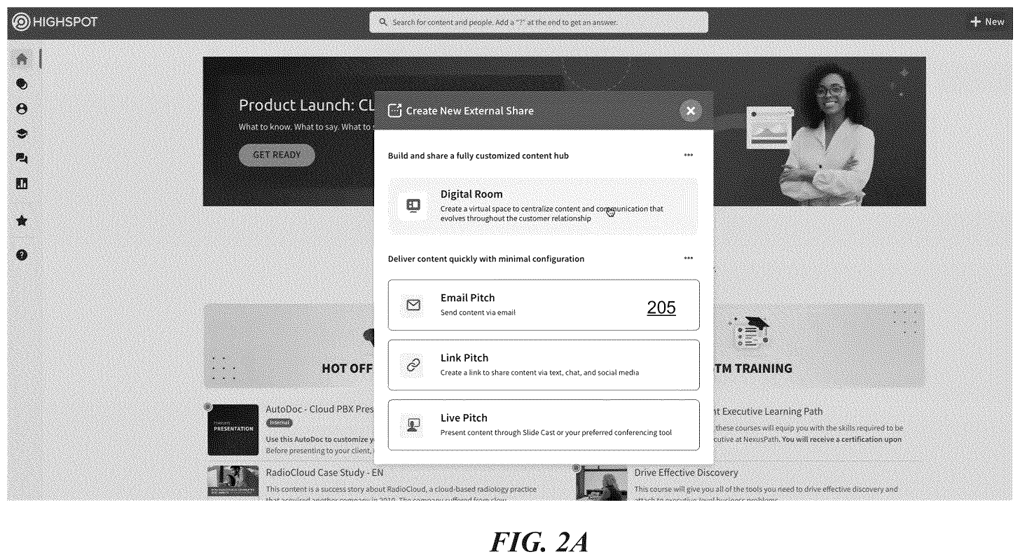

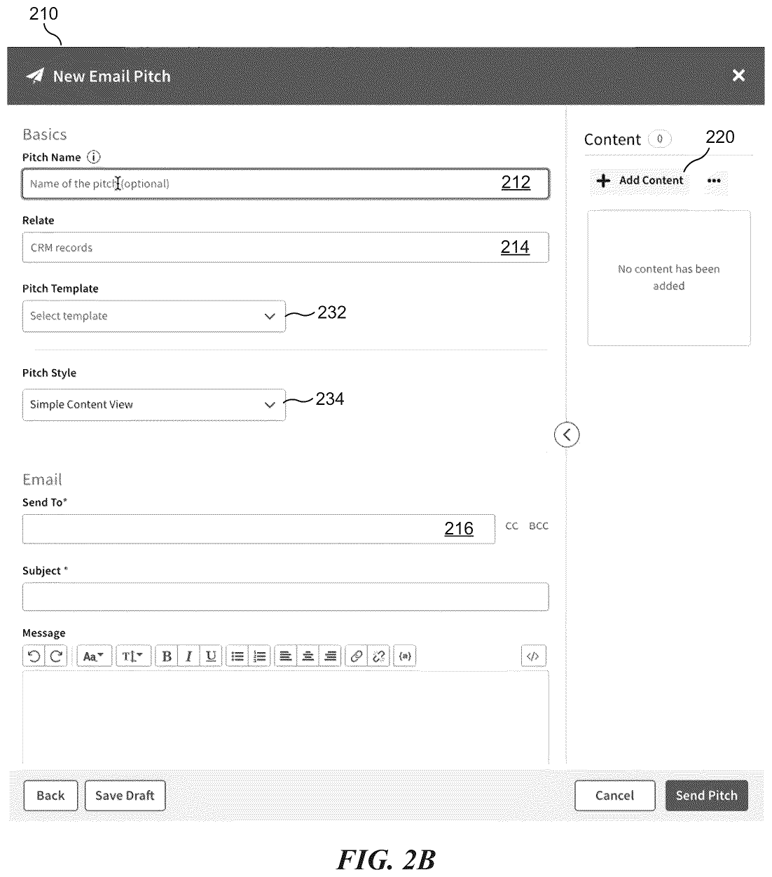

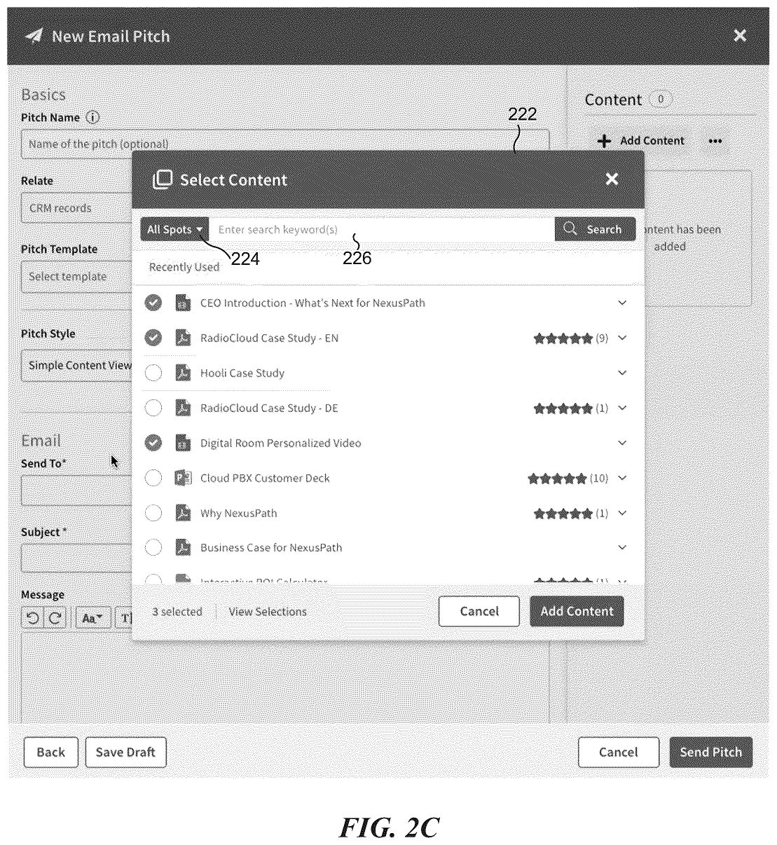

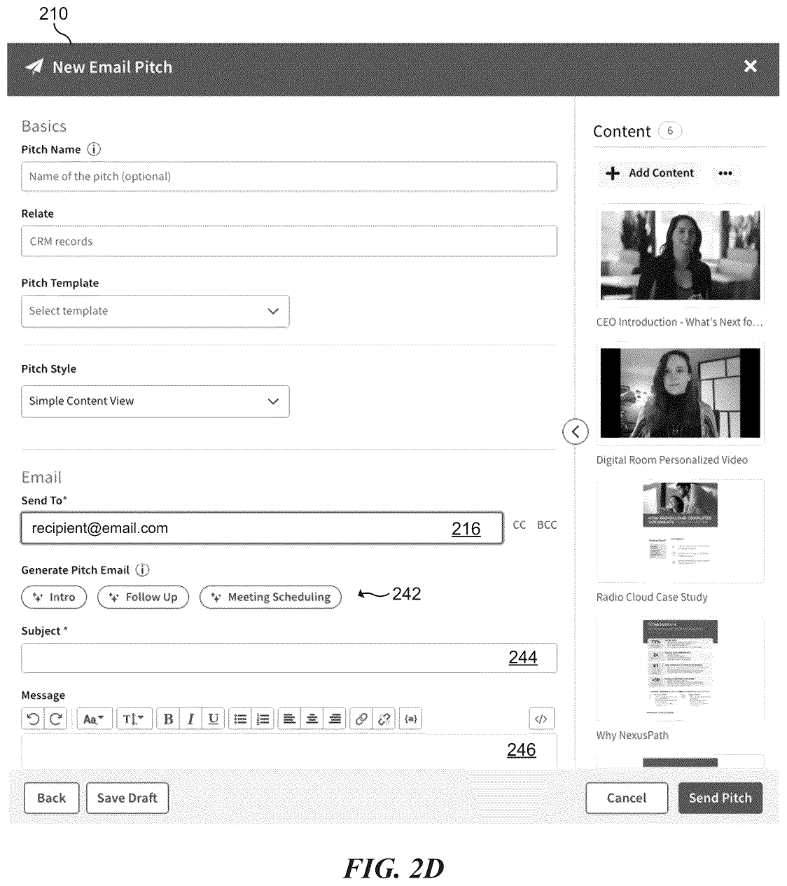

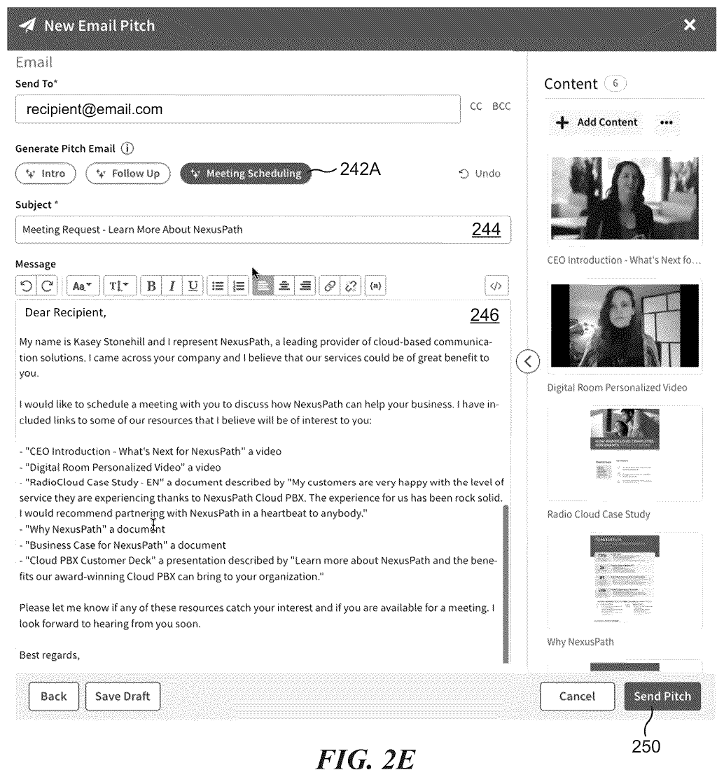

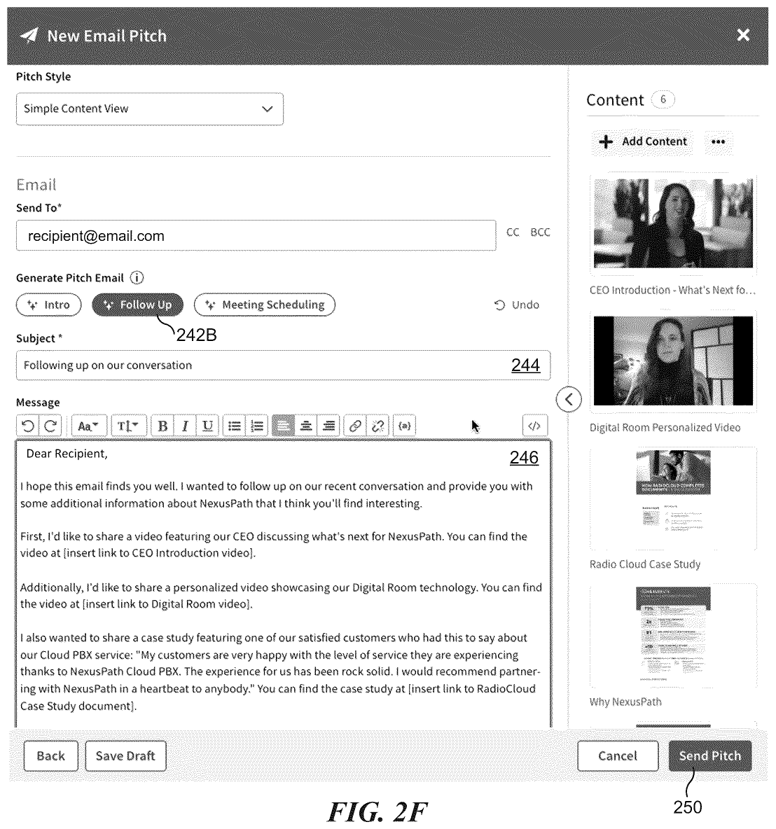

FIGS. 2A-2F are example user interfaces that illustrate a process by which messages are generated, according to some implementations. The illustrated user interfaces can be generated by the content management platform and displayed on a user device

FIG. 2A illustrates an example environment in which a user interacts with a platform, such as a sales enablement platform. The platform can be an environment associated with an organization that enables users associated with the organization to manage content and activities related to the organization. Within the environment, for example, a user can create or interact with content items; create, attend, or manage videoconferencing meetings; send messages to other users of the platform or external organizations; view profiles of other users of the platform or people outside the organization; track performance metrics for people or initiatives; or perform other activities related to the organization.

In some implementations, a user can initiate a process for generating an electronic message from the environment shown in FIG. 2A. For example, FIG. 2A illustrates that a user has selected an element to create a new external share, which causes the environment to display a modal window with options to create a digital room, an email pitch, a link pitch, or a live pitch.

A user can select any of the options shown in FIG. 2A to begin generating an electronic message. Alternatively, an input to generate an electronic message can come from other sources. For example, a user interacting with a content viewing or sharing interface can select an option to share a content item with another person, which can cause the content management platform 110 to generate a message to accompany the shared content. In another example, a user selects an option to generate a new message in a message platform associated with the content management platform 110 or a third-party message platform. The request can instead be received from a person who would like to be a recipient of a message and who may not be a user of the content management system. For example, a prospective client of an organization may submit a request through the organization's webpage for information about the organization's services. The webpage request is processed by the content management platform 110 as a request to generate a message to send to the prospective client.

FIG. 2B illustrates an example user interface 210 that is displayed when a user selects the option to generate an email pitch 205 in FIG. 2A. FIG. 2B illustrates an interface for generating a sales pitch message, as an example type of electronic message that can be generated by the content management platform. However, similar user interfaces can be used to generate other types of electronic messages. As shown in FIG. 2B, the user can input a name for the pitch, if desired, via a text box 212, and can select any CRM records with which the pitch message is to be related. The user can also select a pitch template from a menu 232 or create a new pitch template, or select a pitch style from the menu 234 or create a new pitch style. A pitch template can specify certain formatting or content parameters for the message. When a pitch template is selected, the content management platform 110 can modify message content received from the LLM to conform to the template, or can include the template in a prompt to the LLM to cause the LLM to output conforming content. The pitch style can specify, for example, whether the message should be “formal” or “casual.” When a pitch style is selected, the content management platform 110 can include the selected style in the prompt to the LLM that instructs the LLM to generate the message content.

As the user interacts with the user interface 210, the content management platform receives various signals that can be either used directly to generate an electronic message, or used to retrieve or generate data that is used to generate the message.

One signal received by the content management platform is an identification of the user who will be sending the electronic message. In some implementations, a user logs into an account on the platform prior to or as part of initiating the process for generating the message, and the platform retrieves the sender information from the login. Using the login information, the platform can retrieve biographical details of the sender, such as the sender's name, contact information, and/or job title. The platform can also access the sender's history associated with the platform, such as messages the sender has previously sent, meetings the sender has attended, content items the sender has created or recently accessed, lists or collections of content items the sender has created, etc.

The platform can also receive an identification of a recipient of the message. The user can interact with the interface 210 to input an email address, telephone number, social media profile identifier, or other identifier of a recipient. For example, the user can input an email address for a recipient in an email input box 216. Using the identifier of the recipient, the platform can retrieve information about the recipient. Information can be retrieved, for example, from a profile of the recipient maintained by the platform or by a third-party service (such as a CRM record), and can include biographical details of the recipient, the recipient's recent interactions with the sender or with other users in the sender's organization, the recipient's activities with respect to content items maintained by the platform, etc.

Some implementations of the content management platform generate recommendations for message recipients, which can be provided to the user in a drop-down list or other interactive format. For example, the platform recommends one or more recipients with whom the user has recently interacted, recommends recipients with whom the user has recently had certain types of interactions (such as a recent introductory meeting), or recommends recipients who are determined to be likely to be interested in a content item linked to the message.

The platform can receive an identification of one or more content items that are to be associated with the message. In some implementations, content items are selected by a user, for example when the user selects the “Add Content” button 220 shown in FIG. 2B. When the user selects the button 220, the platform can display a modal window 222, an example of which is shown in FIG. 2C. In the example of FIG. 2C, the window 222 shows a list of content items with which the user recently interacted. The user can select one or more of these content items to link to the message. Alternatively, the user can view content items that have been added to a particular spot or list using the drop-down menu 224, or can search for content items using the search bar 226. Instead of displaying a list of recently used content items, the platform can instead populate the window 222 with a list of items the user recently added to the content repository, items that the user is determined to be likely to be interested in based on the user's activity data, items that are most frequently used by the user or within the user's organization, or a combination of any of these items.

In some implementations, the content management platform recommends a content item to attach to a message, instead of or in addition to receiving explicit user selections of the content items. The recommendation can be based on features of the content item, attributes of the recipient or sender of the message, or a combination of content item features and sender and/or recipient attributes. For example, the platform ingests a record of previous communications with a client being pitched to receive additional services of an organization. The record includes details such as an identify of the client, a type of industry in which the client operates, what stage they are in the pitch for the new services, or types of content items that have been helpful or unhelpful to share with the client in the past. Using this information, the content management platform identifies a content item that is likely to be highly relevant to the client or highly likely to receive a response from the client. For example, the content management platform uses descriptions of candidate content items to score the candidate content items based on a set of criteria for a given client. Example criteria include “relevant to a life science company,” “appropriate for an introductory pitch,” or “shorter than five pages.” The scores can be weighted by factors such as number of views of the content item, number of times the content item has been shared, whether the content item was authored by a subject matter expert, or last edit date of the content item. One or more content items with the highest scores, or scores above a specified threshold, can be recommended for attachment to the message. The content management platform 110 can also output to the user the criteria used to select the recommended content item or the description of the recommended content item, enabling the user to evaluate the reason why the content item was recommended. Alternatively, the content management platform 110 can employ a trained model that evaluates features of the recipient and the content item descriptions to identify a recommendation.

FIG. 2D illustrates an example of the user interface 210 after the user has selected six content items to link to the message and has populated a recipient email into the email input box 216. As shown, the platform adds options 242 for types of pitch emails to be generated and sent to the email address identified in the email input box 216. When a user selects one of the options 242, the platform generates a prompt to the LLM 140 to populate the subject line 244 and message content 246.

The options 242 for message types can be preconfigured types of messages. Selection of these preconfigured options can cause the platform to generate different types of prompts to the LLM, based on the type of message to be generated. For example, the platform can retrieve preconfigured prompt templates that correspond to each of the message types.

Instead of offering preconfigured message type options, the platform can generate recommendations for types of messages to be sent, based at least in part on an identify of the sender, an identity of the recipient, or previous interactions with the recipient. Message type recommendations can be generated using a model or a set of rules that evaluate data associated with the message sender, data associated with the message recipient, or historical communication data. For example, the system uses a job role of the message sender to select the message type, recommending that the message type should be an introductory sales pitch when the message sender is a sales representative. Historical communication data can be used, for example, to determine whether previous messages have been sent to the recipient or previous meetings have been held with the recipient. For example, when no user in the sender's organization has previously contacted the recipient, the platform can provide options for an “Intro” message or a “Meeting Scheduling” message. On the other hand, if the sender (or another user in the sender's organization) has previously sent the recipient an intro message or had a meeting with the recipient, the platform can recommend a follow-up message, another meeting invitation, or a message that responds to an inquiry by the message recipient. Furthermore, instead of providing the message type options, the platform may automatically recommend that the user send a particular message type or

FIGS. 2E-2F illustrate example message content that is generated after the user selects the “Meeting Scheduling” option 242A (FIG. 2E) and the “Follow Up” option 242B (FIG. 2F). As shown in the figures, content generated by the LLM or generated based on an output of the LLM is populated into the user interface 210. For an email, for example, the content can include both a subject line 244 and message content 246. The message content 246 includes a summary of any content items that are attached to the message. Although only text-based content is shown in FIGS. 2E and 2F, the LLM can be prompted to generate any of a variety of data modalities. For example, the LLM can output image or video data, such as an image or video selected from one of the content items that the LLM determines to be particularly relevant, an image or video used in other related messages or pitches, or an image or video generated by the LLM based on the content items attached to the message (e.g., to summarize the content item).

In some implementations, the content management platform performs some processing of the content output from the LLM prior to populating the user interface. For example, the content management platform may apply formatting to plaintext or partially formatted content from the LLM, or may populate certain known data items into the message (such as the name of the recipient, or a name and/or email signature of the sender).

The user can modify the content within the user interface if desired. Once the user is satisfied with the message, and with or without the user modifying any of the text in the user interface 210, the user can select the “Send Pitch” button 250 to send the message. In some implementations, selection of the “send” button causes the content management platform to format the message for transmission and to transmit the message to the recipient. For example, for an email, the content management platform generates an email structure with a header appended to a body that contains the message content, where the header includes all information necessary to transmit the email to the recipient (such as source and destination addresses and date and time of transmission). Alternatively, activation of the “send” button 250 causes the platform to call an application programming interface to open the message in another application, such as an email application or a social media application, where the user can then send the message.

When sending the message, any content items identified for association with the message can be attached to the message. Depending on the type of message, a content item may be attached to a message in different ways. For example, for an email, the content item can be transmitted as an email attachment to the email, or a link to the content item can be provided in the body of the email. For a social media post, a link to the content item can be embedded in the post.

### Automatically Generating Electronic Messages

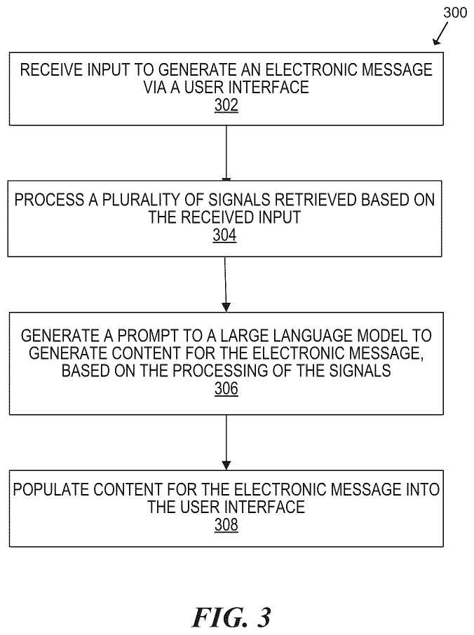

FIG. 3 is a flowchart illustrating a process 300 for generating electronic messages, according to some implementations. The process shown in FIG. 3 can be performed by a computing device or system, such as the content management platform or a computing system in communication with the content management platform. Other implementations of the process 300 can include additional, fewer, or different steps, or can perform the steps in different orders.

At 302, the computer system receives an input to generate an electronic message. The input can be received at a user interface such as the interface 210 described above, which can be generated by the computer system and displayed by a user device. For example, the user interface can be generated within a web application or native application on the user device.

The input to generate the message can include an identifier of the sender of the message, which can be explicitly provided by the user or retrieved from a user account that is logged in to the computer system prior to the input being received. The input can also include other information, such as an identification of content items to be associated with the message, an identifier of a recipient of the message, or a message type for the message.

In some implementations, the computer system recommends that a user generate a message, instead of, or in addition to, receiving the input from the user. The computer system can execute rules that causes the system to recommend messages upon detecting certain criteria. For example, the system analyzes calendar events to determine that a user of the system held a meeting with a client. After the meeting, the system recommends that the user send a follow-up message to the client. In another example, the system detects when a person outside of an organization accesses a document or a webpage distributed by the organization. In response, the system recommends that a representative of the organization send a message to the person who accessed the content. The computer system can additionally or alternatively apply machine learning-based techniques to predict when messages should be sent to achieve a specified metric, such as a likelihood of receiving a response to the message. These techniques can use trained models that evaluate signals such as timing of past communications to and from the intended recipient, frequency of past communications to the recipient, frequency of response to past communications from the intended recipient, location of the recipient, or other communications with or interactions from the recipient that are recent or ongoing.

At 304, the computer system processes a plurality of signals that are retrieved based on the input to generate the message. The signals can include, for example, information about the sender, information about the recipient, metadata or use data associated with content items, CRM data, feedback on previously generated messages, or performance metrics associated with performance of prior-sent messages.

The signals retrieved by the computer system can include metadata associated with any content items that are identified to be associated with the message. The metadata can include, for example, a title of the content item, an author of the content item, a type of the content item (e.g., a document, a slide deck, or a video), or a description of the content item. With respect to content item description metadata, some content descriptions are generated by a user, and include information such as a summary of the content item, the author of the content item, date content as created, date content was last modified, modification history, access rights, and so on. In some implementations, the computer system uses the LLM to generate descriptions for content items stored by or available to the system. The description of a content item that is generated by the LLM can include a summary of subject matter of the content item and/or key highlights from the content item, as well as an explanation of how the content item should be used. The explanation of how the content item should be used can include a purpose of the content item and/or a target audience for the content item. For example, the description can explain that a content item is “an outline of the 2023 version of the Strategic Framework for company executives,” “an introduction to Highspot's sales management tools for sales representatives,” or “a technical presentation on new designs for Product X for engineers.” Descriptions can also include information that, for example, differentiates a document from other similar documents, shares a cadence of updating of the document, identifies when a document is an outdated version of a newer document or vice versa, or provides other details that may be salient for a user to quickly understand the content of a document and how the document should be used.

The signals can further include use data associated with content items. The use data can include categorization of the content item, such as identifying any lists or spots to which the content item has been added. Processing such use data can include determining what the content item is, how it should be used, or whether it is related to other content items based on the other content items in the same list or spot. The use data can also characterize user activity related to content items, such as viewing the item, modifying the item, sharing the item, annotating the item, dwelling at a certain location within the item, etc. Processing user activity data associated content items can enable the computer system to, for example, determine whether the recipient has seen the content item before, identify portions of the content item that are most likely to be interesting or relevant to the recipient, or determine relationships between content items. For example, if user activity data indicates that users typically spend significantly more time reading a certain section of a document than other sections of the document, the computer system can prompt the LLM to generate a summary of the certain section in addition to or instead of summarizing the document as a whole. In another example, the computer system or can determine, based on the use data, that users typically spent more time reading a second content item if they first accessed a first content item, and less or no time reading the second content item if they did not access the first content item first. Accordingly, when generating the message content, the system or LLM can therefore indicate that the second content item should be read after the first.

At 306, the computer system generates a prompt to a large language model (LLM) based on the processing of the signals. The prompt instructs the LLM to generate content for the electronic message.

In some implementations, the prompt to the LLM is generated based on a prompt template. The prompt template can be selected from a preconfigured set of prompt templates, based on the message type selected by the sender or recommended by the system. The prompt to the LLM can include information obtained from the signals processed by the computer system that are populated into the prompt template at the time of prompt generation. For example, the prompt can include information about the sender and the recipient to populate the sender's and recipient's details into the message, such as name of the sender, name of the recipient, pronouns or title of the recipient (e.g., Dr., Mr., Ms.), sender's email or phone number, and/or URL of the sender's organization.

In some implementations, the prompt also includes additional information about the sender or the recipient to cause the LLM to customize the message for a particular sender or recipient. For example, the prompt includes information about a location of the recipient to enable the LLM to modify greetings, formality of the message, or directness of the message to conform to cultural customs of the recipient. In another example, the computer system sends the LLM past communications from the recipient to enable the LLM to evaluate tone or style of the past communications and to mimic the recipient's tone or style in the new message. Similarly, the computer system can send the LLM past communications from the sender to enable the LLM to mimic the sender's tone or style.

In other implementations, the computer system preprocesses signals related to the sender or recipient in order to modify the prompt into the LLM, rather than instructing the LLM to process these signals. For example, the computer system can employ other rule-based or machine learning-based models that evaluate attributes of the sender or recipient in order to select features for the message to be generated. These prompt generation models can select message features that include, for example, length of the message, formatting of the message, style or tone of the message, or number of content items that can be associated with the message. These features can then be directly specified in a prompt. The attributes of the sender and/or recipient that are evaluated by the rule-based or machine learning-based models can include attributes such as tone or style of previous messages sent by the sender or by the recipient, job title or role information of the recipient, performance metrics that indicate whether the recipient responded to past messages and features of the messages that did and did not lead to a response, or attributes of people who are similar to the sender or recipient (e.g., in similar job roles, at similar seniority levels, based in similar locations, or having similar activity data related to content items on the content management platform). As new messages are sent and received within the platform, the computer system can periodically update the prompt generation models. For example, the computer system can retrain a machine learning-based prompt generation model based on features of historical messages and performance metrics associated with the historical messages, such that the performance metric increases over time. In another example, the computer system can retrain a prompt generation model based on implicit or explicit feedback received from a user, such as thumbs-up or thumbs-down signals input by a user, or based on detected changes a sender makes to a message prior to sending the message.

At 308, the computer system populates content for the electronic message into the user interface. The content for the message can be populated based on the output from the LLM.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN can encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification, etc.) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a “language model”), the training dataset may be a collection of text documents, referred to as a “text corpus” (or simply referred to as a “corpus”). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus can be created by extracting text from online webpages and/or publicly available social media posts. Training data can be annotated with ground truth labels (e.g., each data entry in the training dataset can be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data can be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters can be determined based on the measured performance of one or more of the trained ML models, and the first step of training (e.g., with the training set) may begin again on a different ML model described by the new set of determined hyperparameters. In this way, these steps can be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (e.g., update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (e.g., “learn”) the parameters to reduce the loss function. Backpropagation is performed iteratively so that the loss function is converged or minimized. Other techniques for learning the parameters of the ML model can be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters can then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” can refer to an ML-based language model (e.g., a language model that is implemented using a neural network or other ML architecture), unless stated otherwise. For example, unless stated otherwise, the “language model” encompasses LLMs.

A language model can use a neural network (typically a DNN) to perform natural language processing (NLP) tasks. A language model can be trained to model how words relate to each other in a textual sequence, based on probabilities. A language model may contain hundreds of thousands of learned parameters or, in the case of an LLM, can contain millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

A type of neural network architecture, referred to as a “transformer,” can be used for language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

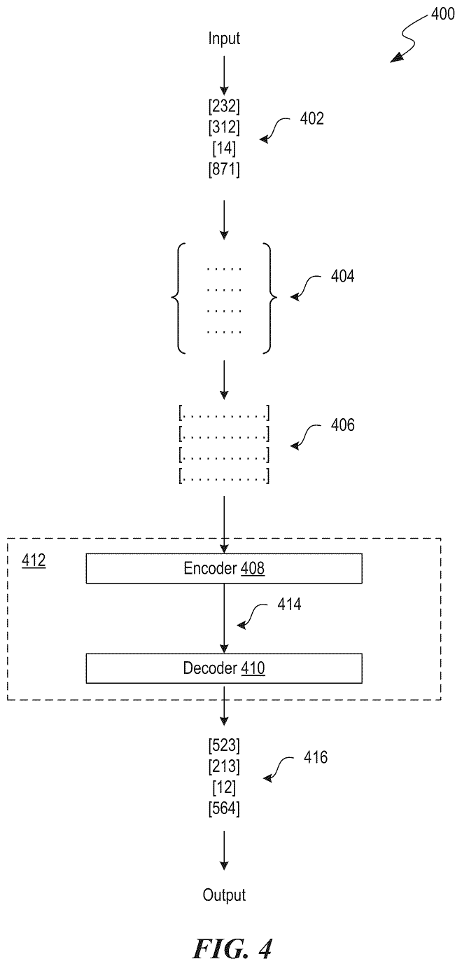

FIG. 4 is a block diagram of an example transformer 412. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, the present disclosure may be applicable to any ML-based language model, including language models based on other neural network architectures such as recurrent neural network (RNN)-based language models.

The transformer 412 includes an encoder 408 (which can include one or more encoder layers/blocks connected in series) and a decoder 410 (which can include one or more decoder layers/blocks connected in series). Generally, the encoder 408 and the decoder 410 each include multiple neural network layers, at least one of which can be a self-attention layer. The parameters of the neural network layers can be referred to as the parameters of the language model.

The transformer 412 can be trained to perform certain functions on a natural language input. Examples of the functions include summarizing existing content, brainstorming ideas, writing a rough draft, fixing spelling and grammar, and translating content. Summarizing can include extracting key points or themes from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 412 is trained to perform certain functions on other input formats than natural language input. For example, the input can include objects, images, audio content, or video content, or a combination thereof.

The transformer 412 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input).

FIG. 4 illustrates an example of how the transformer 412 can process textual input data. Input to a language model (whether transformer-based or otherwise) typically is in the form of natural language that can be parsed into tokens. The term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some implementations, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 4, a short sequence of tokens 402 corresponding to the input text is illustrated as input to the transformer 412. Tokenization of the text sequence into the tokens 402 can be performed by some pre-processing tokenization module such as, for example, a byte-pair encoding tokenizer (the “pre” referring to the tokenization occurring prior to the processing of the tokenized input by the LLM), which is not shown in FIG. 4 for brevity. In general, the token sequence that is inputted to the transformer 412 can be of any length up to a maximum length defined based on the dimensions of the transformer 412. Each token 402 in the token sequence is converted into an embedding vector 406 (also referred to as “embedding 406”).

An embedding 406 is a learned numerical representation (such as, for example, a vector) of a token that captures some semantic meaning of the text segment represented by the token 402. The embedding 406 represents the text segment corresponding to the token 402 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 406 corresponding to the “write” token will be closer to another embedding corresponding to the “jot down” token in the vector space as compared to the distance between the embedding 406 corresponding to the “write” token and another embedding corresponding to the “summary” token.

The vector space can be defined by the dimensions and values of the embedding vectors. Various techniques can be used to convert a token 402 to an embedding 406. For example, another trained ML model can be used to convert the token 402 into an embedding 406. In particular, another trained ML model can be used to convert the token 402 into an embedding 406 in a way that encodes additional information into the embedding 406 (e.g., a trained ML model can encode positional information about the position of the token 402 in the text sequence into the embedding 406). In some implementations, the numerical value of the token 402 can be used to look up the corresponding embedding in an embedding matrix 404, which can be learned during training of the transformer 412.

The generated embeddings 406 are input into the encoder 408. The encoder 408 serves to encode the embeddings 406 into feature vectors 414 that represent the latent features of the embeddings 406. The encoder 408 can encode positional information (i.e., information about the sequence of the input) in the feature vectors 414. The feature vectors 414 can have very high dimensionality (e.g., on the order of thousands or tens of thousands), with each element in a feature vector 414 corresponding to a respective feature. The numerical weight of each element in a feature vector 414 represents the importance of the corresponding feature. The space of all possible feature vectors 414 that can be generated by the encoder 408 can be referred to as a latent space or feature space.

Conceptually, the decoder 410 is designed to map the features represented by the feature vectors 414 into meaningful output, which can depend on the task that was assigned to the transformer 412. For example, if the transformer 412 is used for a translation task, the decoder 410 can map the feature vectors 414 into text output in a target language different from the language of the original tokens 402. Generally, in a generative language model, the decoder 410 serves to decode the feature vectors 414 into a sequence of tokens. The decoder 410 can generate output tokens 416 one by one. Each output token 416 can be fed back as input to the decoder 410 in order to generate the next output token 416. By feeding back the generated output and applying self-attention, the decoder 410 can generate a sequence of output tokens 416 that has sequential meaning (e.g., the resulting output text sequence is understandable as a sentence and obeys grammatical rules). The decoder 410 can generate output tokens 416 until a special [EOT] token (indicating the end of the text) is generated. The resulting sequence of output tokens 416 can then be converted to a text sequence in post-processing. For example, each output token 416 can be an integer number that corresponds to a vocabulary index. By looking up the text segment using the vocabulary index, the text segment corresponding to each output token 416 can be retrieved, the text segments can be concatenated together, and the final output text sequence can be obtained.

In some implementations, the input provided to the transformer 412 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user and the output can include a high-level summary of the meeting notes. In other examples, the input provided to the transformer includes a question or a request to generate text. The output can include a response to the question, text associated with the request, or a list of ideas associated with the request. For example, the input can include the question “What is the weather like in San Francisco?” and the output can include a description of the weather in San Francisco. As another example, the input can include a request to brainstorm names for a flower shop and the output can include a list of relevant names.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via an API (e.g., the API 328 in FIG. 3). As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Computer System

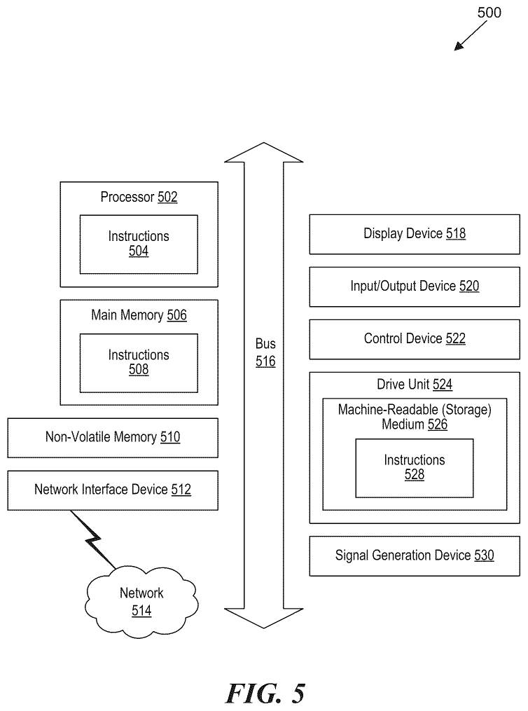

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, video display device 518, an input/output device 520, a control device 522 (e.g., keyboard and pointing device), a drive unit 524 that includes a storage medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementation, the computer system 500 can be an embedded computer system, a system-on-chip (SOC), a single-board computer system (SBC) or a distributed system such as a mesh of computer systems or include one or more cloud components in one or more networks. Where appropriate, one or more computer systems 500 can perform operations in real-time, near real-time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable (storage) medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### Remarks

The terms “example”, “embodiment” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

1. A computer-implemented method comprising:
receiving, at a user interface generated by a computer system for display by a user device, an input to generate an electronic message, wherein the input to generate the electronic message includes an identification of one or more digital content items to be associated with the electronic message;
processing, by the computer system, a plurality of signals retrieved based on the received input,
wherein the plurality of signals include content metadata associated with the one or more digital content items;
generating, by the computer system, a prompt to a large language model (LLM) to cause the LLM to generate content for the electronic message, wherein the prompt is generated at least in part based on the processing of the plurality of signals and instructs the LLM to generate a summary of the one or more digital content items for inclusion in the electronic message based on the content metadata;
populating, into the user interface, content for the electronic message that is generated based on output by the LLM; and
generating a transmissible payload that includes the content for the electronic message and the one or more digital content items attached to or linked within the transmissible payload.

2. The computer-implemented method of claim 1, wherein the plurality of signals include an identifier of a sender of the electronic message, and wherein the identifier of the sender is retrieved based on a login to a user account prior to the input to generate the electronic message being received.

3. The computer-implemented method of claim 1, wherein the plurality of signals include an identifier of a recipient for the electronic message, and wherein the identifier of the recipient is input at the user interface in association with the input to generate the electronic message.

4. The computer-implemented method of claim 3, wherein processing the plurality of signals comprises processing the identifier of the recipient to select message features for the electronic message, and wherein generating the prompt to the LLM comprises instructing the LLM to generate the content for the electronic message using the selected message features.

5. The computer-implemented method of claim 1, wherein the plurality of signals further include use data that characterizes user activity associated with the one or more digital content items.

6. The computer-implemented method of claim 1, wherein the plurality of signals include performance metrics associated with a plurality of prior electronic messages transmitted to respective recipients, and wherein processing the performance metrics comprises:
using the performance metrics to modify a prompt generation model; and
using the modified prompt generation model to generate the prompt to the LLM.

7. The computer-implemented method of claim 6, wherein the performance metrics characterize one or more of:
a number of the prior electronic messages that were read by the respective recipients;
a number of content items attached to the prior messages that were accessed by the respective recipients after the prior messages were transmitted to the respective recipients; or
a number of actions taken by the respective recipients after the prior messages were transmitted to the respective recipients.

8. The computer-implemented method of claim 1, wherein the plurality of signals include an identification of a category of electronic message to be sent, and wherein the prompt to the LLM specifies the identified category.

9. The computer-implemented method of claim 1, wherein populating the content for the electronic message into the user interface comprises generating a subject line and message body for the electronic message, and wherein the transmissible payload includes the subject line, message body.

10. A non-transitory computer-readable storage medium storing executable computer program instructions, the computer program instructions when executed by one or more processors of a system causing the system to:
receive, at a user interface generated by the system for display by a user device, an input to generate an electronic message;
process a plurality of signals retrieved based on the received input;
generate a prompt to a large language model (LLM) to cause the LLM to generate content for the electronic message, wherein the prompt is generated at least in part based on the processing of the plurality of signals; and
populate, into the user interface, content for the electronic message that is generated based on output by the LLM.

11. The non-transitory computer-readable storage medium of claim 10, wherein the plurality of signals include an identifier of a sender of the electronic message, and wherein the identifier of the sender is retrieved based on a login to a user account prior to the input to generate the electronic message being received.

12. The non-transitory computer-readable storage medium of claim 10, wherein the plurality of signals include an identifier of a recipient for the electronic message, and wherein the identifier of the recipient is input at the user interface in association with the input to generate the electronic message.

13. The non-transitory computer-readable storage medium of claim 10:
wherein the input to generate the electronic message includes an identification of one or more digital content items to be associated with the electronic message;
wherein the plurality of signals include content metadata associated with the one or more digital content items; and
wherein the prompt instructs the LLM to generate a summary of the one or more digital content items for inclusion in the electronic message based on the content metadata.

14. The non-transitory computer-readable storage medium of claim 10, wherein the plurality of signals include performance metrics associated with a plurality of prior electronic messages transmitted to respective recipients, and wherein processing the performance metrics comprises:
using the performance metrics to modify a prompt generation model; and
using the modified prompt generation model to generate the prompt to the LLM.

15. The non-transitory computer-readable storage medium of claim 10, wherein the instructions when executed further cause the system to:
generating, by the computer system, a transmissible payload for the electronic message, wherein the transmissible payload includes the content for the electronic message and one or more content items attached to or linked within the transmissible payload.

16. A data processing system, comprising:
one or more processors; and
one or more non-transitory computer-readable storage media storing executable computer program instructions, the computer program instructions when executed by the one or more processors cause the data processing system to:
receive, at a user interface generated by the data processing system for display by a user device, an input to generate an electronic message;
process a plurality of signals retrieved based on the received input;
generate a prompt to a large language model (LLM) to cause the LLM to generate content for the electronic message, wherein the prompt is generated at least in part based on the processing of the plurality of signals; and
populate, into the user interface, content for the electronic message that is generated based on output by the LLM.

17. The data processing system of claim 16, wherein the plurality of signals include an identifier of a recipient for the electronic message, and wherein the identifier of the recipient is input at the user interface in association with the input to generate the electronic message.

18. The data processing system of claim 16:
wherein the input to generate the electronic message includes an identification of one or more digital content items to be associated with the electronic message;
wherein the plurality of signals include content metadata associated with the one or more digital content items; and
wherein the prompt instructs the LLM to generate a summary of the one or more digital content items for inclusion in the electronic message based on the content metadata.

19. The data processing system of claim 16, wherein the plurality of signals include performance metrics associated with a plurality of prior electronic messages transmitted to respective recipients, and wherein processing the performance metrics comprises:
using the performance metrics to modify a prompt generation model; and
using the modified prompt generation model to generate the prompt to the LLM.

20. The data processing system of claim 16, wherein the instructions when executed further cause the system to:
generating, by the computer system, a transmissible payload for the electronic message, wherein the transmissible payload includes the content for the electronic message and one or more content items attached to or linked within the transmissible payload.
